(19) United States
(12) Patent Application Publication
(10) Pub. No.: US 2022/0369570 A1
(43) Pub. Date: Nov. 24, 2022

(54) Rotating Planter

(71) Applicant: David Lord, Muskegon, MI (US)

(72) Inventor: David Lord, Muskegon, MI (US)

(21) Appl. No.: 17/324,628

(22) Filed: May 19, 2021

(51) Int. Cl. A01G 9/02; A01G 9/12

(52) U.S. Cl. CPC A01G 9/02; A01G 9/12

(57) ABSTRACT

The rotating plant pot is a device whereby plants of varying sizes can be grown indoors with a balanced appearance and growth. The plant pot is stationed on an elevated plane for viewing pleasure, and the weight of the pot, plant, and any soil, is centered on an axle on said table. This design decreases the amount of torque needed to rotate even a large plant, such that it can be done manually by the gardener, or a motor can be installed which can spin the plant at a constant or varying rate. Vertical towers extend from the base of the pot to the surface level to secure plant fences, which can hold the plant upright and assist the plant's vertical growth. The disclosure additionally includes a spring configured with a predetermined spring constant to unwind and rotate the pot according to the adjustable rotation rate.

### BACKGROUND

A plant pot is a container in which flowers and other plants are cultivated and displayed. Historically, and still to a significant extent today, they are made from plain terracotta with no ceramic glaze, with a round shape, tapering inwards. Flowerpots are now often also made from plastic, metal, wood, stone, or sometimes biodegradable material. An example of biodegradable pots are ones made of heavy brown paper, cardboard, or peat moss in which young plants for transplanting are grown. There have been no products available as original equipment or as an aftermarket to address this problem.

Plants grow toward light, and since interior light sources are often fixed, houseplants will begin to grow towards the light. Thus, If a plant is left to its own devices, it can begin to tilt or grow off-balanced toward the light. To maintain the appearance of the plant for the long term, manual plant rotation is sometimes used. These rotations will produce growth and productivity where foliage is exposed to the light. There have been no products available as original equipment or as an aftermarket to address this problem either.

There exists a need for a rotating plant pot device that is not being met by any known or disclosed device or system of present.

### SUMMARY OF THE INVENTION

The rotating plant pot is a device whereby plants of varying sizes can be grown indoors with a balanced appearance and growth. The plant pot is stationed on an elevated plane for viewing pleasure, and the weight of the pot, plant, and any soil, is centered on an axle on said table. This design decreases the amount of torque needed to rotate even a large plant, such that it can be done manually by the gardener, or a motor can be installed which can spin the plant at a constant rate. For further facility of maintaining the plant appearance, vertical towers extend from the base of the pot to the surface level. These towers can be used to secure plant fences, which can hold the plant upright and assist the plant's vertical growth.

The disclosed plant pot device includes a pot for a plant, wherein the plant has a center of gravity directly over a center of a bottom of the pot. The disclosure also includes a rotating axle disposed beneath the pot, the rotating axle having a varying rotation rate. The disclosure additionally includes a spring configured with a predetermined spring constant to unwind and rotate the pot according to the adjustable rotation rate. The disclosure further includes a counter spring configured with a smaller spring constant than the predetermined spring constant to windup based on the spring winding down and counter rotate the pot for a time. Embodiments of the disclosure include a counter spring configured with a larger spring constant than the predetermined spring constant to windup based on the spring winding down and counter rotate the pot for a time. Embodiments of the disclosure yet include a flywheel disposed in the pot configured to give an angular momentum and smooth out the varying rotation rate.

### BRIEF DESCRIPTION OF THE DRAWINGS

FIG. 1 is a front view of the rotating plant pot device in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure the term “counter spring” is used to refer to a spring wound counter to another spring. The term “spring constant” refers to a Hooke's law constant of spring force.

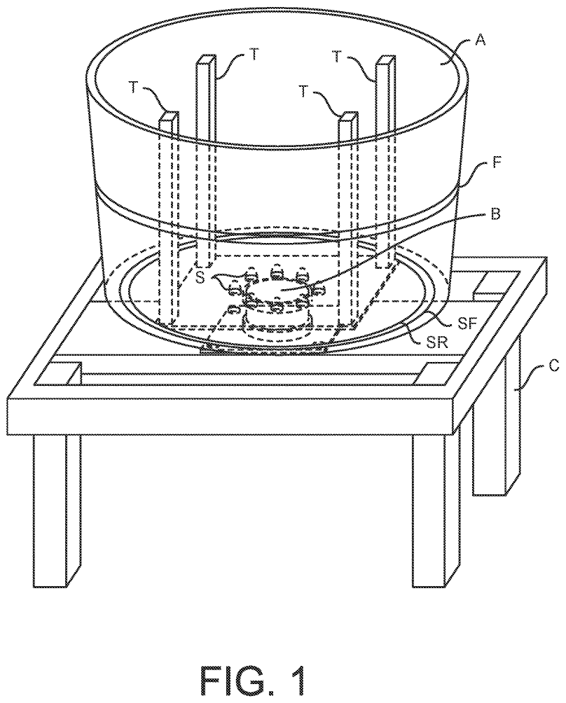

FIG. 1 is a front view of the rotating plant pot device in accordance with an embodiment of the present disclosure. The pot A is connected to the table base C by the means of a spinning axle B and spikes or rods S for attachment to the pot. The attached pot A can be a variety of sizes, but the device is especially useful for large pots that would be difficult to rotate otherwise. All of the weight of the plant on the pot A is centered on the axle B which coincidentally is the center of the bottom of the pot A, which allows the gardener the ease of manually rotating the pot A, or a motor can be installed to rotate the pot A automatically. Additionally, there are towers T that extend from the base of the rotating pot A. These towers T allow for the gardener to secure a plant fence to hold the plant up and keep it in place relatively to the pot A. The flywheel F on or in the pot may also be attached to the axle B in embodiments. The flywheel gives angular momentum to the rotating pot and therefore gives a constant rotating rate to an otherwise varying rotation rate. The forward spring SF in one direction and the reverse spring SR or counterspring wound in another direction are depicted in a plate-like structure beneath the pot A and in some embodiments are included in the pot A.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A plant pot device comprising:
a pot for a plant, wherein the plant has a center of gravity directly over a center of a bottom of the pot;
a rotating axle disposed beneath the pot, the rotating axle having a varying rotation rate; and
a spring configured with a predetermined spring constant to unwind and rotate the pot according to the adjustable rotation rate.

2. The plant pot device of claim 1, further comprising a counter spring configured with a smaller spring constant than the predetermined spring constant to windup based on the spring winding down and counter rotate the pot for a time.

3. The plant pot device of claim 1, further comprising a counter spring configured with a larger spring constant than the predetermined spring constant to windup based on the spring winding down and counter rotate the pot for a time.

4. The plant pot device of claim 1, further comprising a flywheel disposed in the pot configured to give an angular momentum and smooth out the varying rotation rate.

5. The plant pot device of claim 1, wherein one end of the spring is attached to the axle and another end of the spring is attached to a pedestal housing the axle.

6. The plant pot device of claim 1, further comprising a flywheel disposed in the rotating axle configured to give an angular momentum and smooth out the varying rotation rate.

7. The plant pot device of claim 1, wherein the axle and the spring are comprised in a plate-like housing configured to sit atop a pedestal.

8. The plant pot device of claim 1, further comprising a plurality of towers configured to extend a depth of the pot for a support to accessories thereto.

9. The plant pot device of claim 8, wherein the accessories comprise a plant trellis.

10. The plant pot device of claim 1, wherein the varying rotation rate is set by a torque force via a user of the plant pot device.

11. The plant pot device of claim 1, wherein the varying rotation rate is set by a servomechanism configured to power the rotating axle at the varying rotation rate.

12. The plant pot device of claim 1, further comprising a soil in the pot, the soil also having a center of gravity combined with the plant directly over the bottom center of the pot.

13. The plant pot device of claim 1, further comprising a plurality of rods configured to extend from the axle into watering holes of the plant pot.

14. The plant pot device of claim 1, further comprising a plurality of spikes configured to extend from the axle and penetrate the pot for fastening it thereto.

15. The plant pot device of claim 1, wherein the adjustable rotation rate is an integer fraction of 24 hrs for a complete rotation.

16. The plant pot device of claim 1, further comprising an electric eye configured to track a light source.

17. The plant pot device of claim 16, wherein the varying rotation rate is configured to rotate the pot to track the light source.

18. The plant pot device of claim 1, further comprising a slow drip water reservoir accessory on a tower mounted on an inside of the pot.

19. The plant pot device of claim 1, further comprising a solar cell accessory on a tower mounted on an inside of the pot.

20. The plant pot device of claim 1, further comprising a pedestal for the plant pot device to sit thereupon for access to more available light.
